(19) United States
(12) Patent Application Publication
(10) Pub. No.: US 2014/0216025 A1
(43) Pub. Date: Aug. 7, 2014

(54) WAVE ENERGY CONVERTER AND METHOD FOR OPERATING A WAVE ENERGY CONVERTER

(71) Applicants: Benjamin Hagemann, Bad Segeberg (DE); Nik Scharmann, Bietigheim- bissingen (DE); Jos Ritzen, Swalmen (NL)

(72) Inventors: Benjamin Hagemann, Bad Segeberg (DE); Nik Scharmann, Bietigheim- bissingen (DE); Jos Ritzen, Swalmen (NL)

(73) Assignee: Robert Bosch GmbH, Stuttgart (DE)

(21) Appl. No.: 14/126,804

(22) PCT Filed: Apr. 24, 2012
(86) PCT No.: PCT/EP2012/001744

§ 371 Date: Mar. 14, 2014

(30) Foreign Application Priority Data
Jun. 17, 2011 (DE) 10 2011 105 178.7

(51) Int. Cl. F03B 3/12

(52) U.S. Cl. CPC F03B 3/126
USPC 60/495; 415/1

(57) ABSTRACT

A wave energy converter for converting energy from a wave motion of a fluid into a different form of energy includes at least one rotor that is coupled to at least one energy converter. The rotor has a rotor base that has two sides with respect to the rotational plane of the rotor. At least one coupling body is attached to each side of the rotor base.

The invention relates to a wave energy converter for converting energy from a wave motion of a fluid into a different form of energy, and to a corresponding method.

### PRIOR ART

Various devices for converting energy from wave motions in bodies of water into useful energy are known from the prior art; these devices can be used on the high sea or close to the shore. An overview of wave power generators is given, for example, by G. Boyle, “Renewable Energy”, Second Edition, Oxford University Press, Oxford 2004.

Differences arise from, inter alia, the way in which the energy is extracted from the wave motion. Thus, there are known buoys, or floating bodies, which float on the surface of the water, their rise and fall driving, for example, a linear generator. In the case of another machine concept, the so-called “Wave Roller”, a flat drag element is attached to the seabed and is tilted back and forth by the wave motion. The energy of motion of the drag element is converted, for example, into electrical energy, in a generator. In such oscillating systems, however, it is only possible to achieve a maximum damping factor, or load factor, of 0.5, such that their efficiency is generally not satisfactory.

Wave energy converters that are of interest in the context of the present invention are those, in particular, that are disposed substantially below the water surface and in which a crankshaft or rotor shaft is made to rotate by the wave motion.

In this connection, there is known from the publication by Pinkster et al., “A rotating wing for the generation of energy from waves”, 22^{nd} International Workshop on Water Waves and Floating bodies (IWWWFB), Plitvice, 2007, a system concept in which the lift of a lift device subjected to flow, i.e. a coupling body generating a hydrodynamic lift, is converted into a rotational motion.

Further, US 2010/0150716 A1 discloses a system composed of a plurality of high-speed rotors having lift devices, in which the rotor period is less than the wave period, and a separate profile adjustment is performed. It is intended that, as a result of an appropriate adjustment of the lift devices, which, however, is not disclosed in greater detail, resultant forces upon the system are generated, which can be used for various purposes. A disadvantage of the system disclosed in US 2010/0150716 A1 is the use of Voith-Schneider-type high-speed rotors, which require an elaborate system for adjustment of the lift devices. The latter have to be adjusted continuously within a not inconsiderable angular range, in order to be adapted to the respectively prevailing incident flow conditions. Moreover, in order to compensate the forces, resulting from a rotor moment and generator moment, acting on the individual rotors, it is always necessary for a plurality of rotors to be at defined distances in relation to each other.

Accordingly, the invention is based on the object of improving rotating wave energy converters, in particular in respect of a greater energy yield and a less elaborate design and/or a less elaborate control system requirement.

### DISCLOSURE OF THE INVENTION

Against this background, the present invention proposes a wave energy converter and a corresponding operating method, having the features of the independent claims. Preferred designs are also provided by the respective dependent claims and the description that follows.

### ADVANTAGES OF THE INVENTION

Proposed according to the invention is a wave energy converter for converting energy from a wave motion of a fluid into a different form of energy, having at least one rotor, which is coupled to at least one energy converter. The rotor has a rotor base that is two-sided in respect of its rotational plane, wherein at least one coupling body is attached to each side of the rotor base. As a result of this, the forces, acting upon a generator coupled to the rotor, that can be converted into useful energy can be increased and, through selective influencing of effective moments on both sides of the two-sided rotor base, as explained below, the position of a corresponding wave energy converter can be controlled in a selective manner. If the forces acting on the two sides of the two-sided rotor base differ, it is possible to generate a torque upon the rotor that acts perpendicularly in relation to the rotation axis of the two-sided rotor, and thereby to effect a rotation of the wave energy converter. It is thereby possible to achieve a precise alignment, e.g. in relation to a direction of wave direction. In this case, there is no need for all of the coupling bodies to be adjustable; it is sufficient for only some of the coupling bodies to be adjustable. In certain cases, it is also possible to dispense entirely with the ability to adjust the coupling bodies, such that the respectively acting forces can also be selectively influenced solely by a generator moment, as explained below. This results in a particularly robust design and a reduced servicing requirement, particularly taking into consideration the rough conditions on the high sea.

Overall, therefore, at least one coupling body on at least one side of the rotor base is realized so as to be adjustable, wherein corresponding positioning means are provided for adjusting the at least one coupling body on the at least one side of the two-sided rotor base. Various configurations may be advantageous in this case. It is already possible to influence moment differentially on two sides of a corresponding double-sided rotor in that only one coupling body on one side of a double-sided rotor is realized so as to be adjustable, but the other rotor or rotors, in particular on the second side, are not. Alternatively a plurality of coupling bodies, or all coupling bodies, on one side may be realized so as to be adjustable, but those on the other side not. Finally, configurations may also be used in which it is possible to adjust a plurality of coupling bodies, or all coupling bodies, on both sides. Depending on the extent to which adjustment is possible, a design of greater or lesser elaborateness is obtained. The greater the degree of adjustability, the more flexibly a corresponding rotor can be adapted or influenced.

In particular, a plurality of rotors, including one-sided and two-sided rotors, by means of which the same or a different effective force is generated in each case, can be used in a corresponding device or a corresponding method. The generated effective forces can be superposed to form a total force that can be influenced through the respective contributory forces.

An advantageous method comprises the operation of a wave energy converter that has at least one rotor and at least one energy converter coupled to the at least one rotor, wherein a first torque, acting upon the at least one rotor, is generated by the wave motion, and a second torque, acting upon the at least one rotor, is generated by the at least one energy converter. In the case of the double-sided rotor according to the invention, it is understood that the “first” torque is composed of the two “first” torques that act on each side of the rotor. According to the invention, a wanted effective force, acting perpendicularly in relation to a rotation axis of the at least one rotor, is set by setting of the first and/or second torque. As described in detail below, this makes it possible, inter alia, to operate a corresponding wave energy converter, even with only one rotor, since the rotor itself can compensate any moments acting upon it perpendicularly in relation to the rotation axis, or superposed forces, and consequently there is no need for a counteracting force of a second or further rotor.

The invention presented here considers, quite generally, systems that have a rotatory principle of operation, e.g. including converters having a plurality of rotors, e.g. as represented in FIG. 15. The statements that follow therefore apply, in principle, to wave energy converters having one or more rotors.

Provided overall, therefore, is a wave energy converter having at least one, as explained below, rotor rotating, advantageously, in synchronism or largely in synchronism with a wave (orbital) motion or flow, for the purpose of converting energy from a body of water having waves, which wave energy converter is advantageous in respect of its energy yield and control system, and with which, moreover, when appropriately operated or appropriately configured, resulting forces can be influenced and utilized for influencing the system as a whole. By means of such a wave energy converter, with appropriate configuration and operational control, it is possible to achieve virtually a complete extinction, and therefore utilization, of the incident wave. This applies, in particular, to monochromatic waves. Owing to the synchronous or largely synchronous operation, the lift devices used in a corresponding wave energy converter, i.e. the coupling bodies, which are designed to convert a wave motion into a lift force, and therefore into a torque of a rotor, do not have to be adjusted, or they have to be adjusted only to a small extent, since a flow against a corresponding profile is in this case effected, over the entire rotation of the rotor carrying the profile, largely from one same direction of incident flow. Adaptation of an angle of attack γ, as in the case of the known Voith-Schneider rotors (also termed pitching), is therefore not necessary, but may be advantageous.

In sea waves, the water particles move on largely circular, so-called orbital paths (in the form of an orbital motion, or orbital flow, the two terms also being used synonymously). In this case, under a wave peak the wave particles move in the direction of propagation of the wave, under the wave trough they move contrary to the direction of the wave, and in the two zero crossings they move upward and downward, respectively. The direction of flow at a fixed point below the water surfaces (referred to in the following as a local, or instantaneous, incident flow) thus changes continuously, at a certain angular velocity O. In deep water, the orbital flow is largely circular; in shallow water, the circular orbitals increasingly become flat-lying ellipses. A flow can be superposed on the orbital flow.

The orbital radii are dependent on the immersion depth. They are maximal at the surface—here, the orbital diameter corresponds to the wave height—and decrease exponentially as the water depth increases. At a water depth of approximately half the wavelength, therefore, the energy that can be extracted is then only approximately 5% of that which can be extracted close to the surface of the water. For this reason, submerged wave energy converters are preferably operated close to the surface.

Advantageously, a rotor is provided, having a largely horizontal rotor axis and at least one coupling body. The rotor rotates, advantageously, in synchronism with the orbital flow, at an angular velocity w, and is driven by the orbital flow, by means of the at least one coupling body. In other words, the wave motion of the water or, more precisely, its orbital flow, generates a torque (referred to as a “first torque” or “rotor torque/(turning) moment” in the context of this invention), which acts upon the rotor. If the period of the rotational motion of the rotor and that of the orbital flow correspond, at least to a certain extent (see below concerning the term “synchronism” used here), then, apart from the mentioned effect of depth, and effects of width in the case of large rotor diameters, a constant local incident flow is always obtained at the coupling body. As a result, energy can be extracted continuously from the wave motion, and converted by the rotor into a useful torque.

The term “coupling body” in this context is to be understood to mean any structure by which the energy of an incident-flow fluid can be coupled into a rotor motion, or a corresponding rotor moment. As explained below, coupling bodies may be realized, in particular, as lift devices (also referred to as “foils”), but also drag devices.

The term “synchronism” in this case may denote a rotor rotational motion as a result of which, at each instant, a complete correspondence ensues between the position of the rotor and the direction of the local incident flow that arises from the orbital flow. Advantageously, however, a “synchronous” rotor rotational motion can also be effected in such a manner that a defined angle, or a defined angular range (i.e. the phase angle is held within the angular range over one revolution) is obtained between the position of the rotor, or at least of a coupling body disposed on the rotor, and the local incident flow. A defined phase offset, or phase angle Δ, is thus obtained between the rotor rotational motion ω and the orbital flow O. In this case, the “position” of the rotor, or of the at least one coupling body disposed on the rotor, can always be defined, for example, by a notional line through the rotor axis and, for example, the rotation axis or the center of gravity of a coupling body.

Such a synchronism can be derived directly, in particular for monochromatic wave states, i.e. wave states that have a continuously constant orbital flow O. However, under real conditions, i.e. in real sea states, in which the orbital velocity and orbital diameter change as a result of mutual superposition of waves, as a result of wind influence and the like (so-called multichromatic wave states), provision can also be made such that the machine is operated at an angle, in relation to the respectively active incident flow, that is constant only within a certain scope. In this case, an angular range can be defined, within which the synchronism can still be regarded as being maintained. This can be achieved through appropriate control measures, including the adjustment of at least one coupling body for generating the aforementioned first torque and/or a second torque of the energy converter that has a braking or accelerating effect. In this case, there is no need for all of the coupling bodies to be adjusted, or to have a corresponding adjustment facility. In particular, there is no need for synchronous adjustment of a plurality of coupling bodies.

Alternatively, however, provision may also be made to dispense with complete synchronism, in which the incident flow on the at least one coupling body is always effected locally from the same direction. Instead, the rotor can be synchronized to at least one main component of the shaft (e.g. a main mode of superposed waves), and consequently intermittently lead or lag the local flow. This can be achieved through corresponding adjustment of the first and/or second torque. Such operation is also still included under the term “synchronism”, as is a fluctuation of the phase angle within certain ranges that results in the rotor being intermittently able to undergo an acceleration (positive or negative) in relation to the wave phase.

The rotational speed of a “synchronous” or “largely synchronous” rotor therefore corresponds approximately, i.e. within certain limits, to the wave rotational speed prevailing at a particular time. Deviations are not cumulative in this case, but are largely compensated mutually or over time or over a certain time window. An essential aspect of a control method for a corresponding converter may consist in maintaining the explained synchronism.

Particularly preferably, coupling bodies are used from the class of lift devices that, in the case of an incident flow at an incident flow angle a, in addition to generating a drag force in the direction of the local incident flow generate, in particular, a lift force directed substantially perpendicularly in relation to the incident flow. These may be, for example, lift devices having profiles according to the NACA Standard (National Advisory Committee for Aeronautics), but the invention is not limited to such profiles. Particularly preferably, Eppler profiles may be used. In the case of a corresponding rotor, the local incident flow and the incident flow angle a associated therewith results in this case from superposition of the orbital flow v_{wave} in the previously explained local, or instantaneous, wave incident flow direction, the rotational speed of the lift device vᵣₒₜₒᵣ at the rotor, and the angle of attack γ of the lift device. The alignment of the lift device can therefore be optimized to the locally existing incident flow conditions, in particular through adjustment of the angle of attack γ of the at least one lift device. Furthermore, it is also possible to use flaps similar to those on aircraft wings and/or to change the lift profile geometry (so-called “morphing”) in order to influence the incident flow. The said changes are to be included under the term “shape changing”.

The aforementioned first torque—which, as mentioned, might possibly be composed of a plurality of first torques—can therefore be influenced, for example, by means of the angle of attack γ. It is known that, as the incident flow angle a increases, the resultant forces upon the lift device increase, until a drop in the lift coefficient is to be observed at the so-called stall limit, at which a flow separation occurs. The resultant forces likewise increase as the flow speed increases. This means that the resultant forces, and consequently the torque acting upon the rotor, can be influenced as a result of changing the angle of attack γ and, associated therewith, the incident flow angle a.

A second moment acting upon the rotor can be provided by an energy converter coupled to the rotor, or to its rotor base. This second moment, also referred to in the following as a “generator moment”, likewise affects the rotational speed vᵣₒₜₒᵣ and thereby likewise influences the incident flow angle a. In conventionally operated energy generating systems, the second moment constitutes a braking moment that results from the interaction of a generator rotor with the associated stator and that is converted into electrical energy. A corresponding energy converter in the form of a generator can also be operated by motor, however, at least during certain periods, such that the second moment can also act in the form of an acceleration moment upon the rotor. In order to achieve the advantageous synchronism, the generator moment can be set to match the current lift profile setting and the forces/moments resulting therefrom, such that the desired rotational speed is set, with the correct phase shift relative to the orbital flow. The generator moment can be influenced through, inter alia, influencing of an excitation current by the generator rotor (in the case of separately excited machines) and/or through controlling the commutation of a current converter connected in series after the stator.

From the forces at the individual coupling bodies, the vectorial superposition ultimately results in a rotor force that acts upon the housing of the rotor as a bearing force (also referred to as a reaction force) directed perpendicularly in relation to the rotor axis. This force changes its direction continuously, since the incident flow on the rotor and the position of the coupling bodies are also changing continuously. Averaged over time, in the case of a wanted or unwanted asymmetry of the bearing force over time, an effective force is obtained that likewise acts perpendicularly in relation to the rotor axis and that, in the form of a translational force or, in the case of a plurality of rotors, as a combination of translational forces, can influence a position of a corresponding wave energy converter and be used selectively for influencing position. With a corresponding design of the coupling bodies, e.g. with their longitudinal axes disposed obliquely, it is also possible to generate a bearing force directed perpendicularly in relation to the rotor axis, as explained more fully elsewhere in the document.

Since the rotor is preferably realized as a system floating under the surface of a body of water that has waves, the explained rotor force acts as a displacing force upon the rotor as a whole, and must be supported accordingly, if the position of the rotor is not to alter. As mentioned, this is achieved, for example, in US 2010/0150716 A1 through the provision of a plurality of rotors, whose forces counteract each other. In this case, the displacements compensate each other over a revolution, if constant incident flow conditions at the coupling bodies, and the same settings of the angle of attack γ, and thus of the first torque, and a constant second torque are assumed.

Thus, by means of an appropriate change in the rotor force, by influencing the first and/or second torque, while maintaining the synchronism, it is also possible to achieve a situation in which the rotor forces do not compensate each other per revolution, such that, for example, it is possible to achieve a displacement of the rotor perpendicular to its rotation axis.

If a rotor has a plurality of coupling bodies, it can be provided that each coupling body has its own adjustment device, such that the coupling bodies can be set independently of each other. Advantageously, the coupling bodies are set to the locally prevailing flow conditions in each case. This enables depth effects and width effects to be compensated. In the case of the previously explained “synchronous” operation, the generator moment in this case is tuned to the rotor moment generated by the sum of the coupling bodies.

The rotor can have a two-sided mounting for coupling bodies, and an adjustment system, for the at least one coupling body, can be provided on one side or on both sides. Alternatively, an embodiment is provided with a one-sided mounting of the at least one coupling body and with a free end.

Advantageously, for the purpose of carrying the rotor, a housing is provided, on which the rotor is carried in a rotatable manner. The second torque is preferably realized by an energy converter, such as a generator. This may be, in particular, a directly driven generator, since drive train losses are then minimized. Alternatively, however, a transmission may also be interposed. It is also possible to generate a pressure in a suitable medium by means of a pump. This pressure already constitutes a useful form of energy, but it can be converted (again), e.g. by means of a hydraulic motor, into a torque and fed into a generator.

The coupling bodies can be directly or indirectly coupled, via corresponding lever arms, to the rotor of the directly driven generator. The coupling bodies are thus advantageously attached at a distance from the rotation axis. The lever arms in this case may be realized as struts, or correspondingly realized spacing means, that connect the coupling bodies to the rotor, but a lever arm may also be realized by means of a corresponding disk-type structure, and perform only the physical function of a lever. Depending on the design, advantages are then achieved in respect of flow or structural design.

As mentioned, the adjustment system for adjusting the at least one coupling body may be a system for changing the angle of attack γ. Alternatively, it is also possible to adjust flaps on the at least one coupling body, in a manner similar to that of aircraft wings, or to change the coupling body geometry (morphing). The adjustment may be effected by electric motor—preferably by means of stepping motors—and/or hydraulic and/or pneumatically.

As an alternative or in addition to an individual adjustment for each coupling body, a coupled adjustment of the various coupling bodies may be provided, in which the coupling bodies are connected, for example via corresponding adjustment levers, to a central adjustment device. This limits the flexibility of the machine only slightly, but may result in a simplification of the structure as a whole.

For the geometry of the lift devices preferably used, plain extruded/prismatic structures may be used, in which the coupling-body cross section does not vary over the length of the coupling body. However, it is also provided according to the invention, in particular for the case of a one-sided mounting, to use a 3D coupling-body geometry with tapering coupling-body ends and/or a sweep, as also used in aircraft construction. These have a positive effect upon the stability/elastic line of the coupling body. Moreover, tapering of the coupling body at the tip of the coupling body results in reduced boundary vortices, which can cause efficiency losses. Here, moreover, it is also possible to use winglets on one end and/or both ends of the coupling body.

It may be provided that the length and angular position of the lever arm of the at least one lift device can be set, to enable the machine to be adapted to a variety of wave conditions, e.g. differing orbital radii.

Rotors may be used that have the longitudinal axes of their coupling bodies aligned substantially parallel to the rotor axis. The coupling bodies may also be disposed at an angle on the rotor, their longitudinal axes extending obliquely in relation to the rotation axis of the rotor, at least intermittently. The longitudinal axes may converge or diverge, or be disposed with a lateral offset in relation to each other. The angular disposition in this case can relate to both the radial and the tangential alignment. In particular, in this case, an angular disposition of the at least one coupling body that relates to the radial alignment has the effect of stabilizing the performance of the system to a certain extent. A different optimum coupling-body radius is thus obtained for different wave states. As described above, this coupling-body radius can be realized so as to be adjustable. A radial angular disposition of the coupling bodies then has the effect, in particular, that the machine can be operated over a wider range of wave states close to an optimum. The system as a whole thus, to a certain extent, behaves in a more tolerant manner and allows operation over a greater range of wave states, e.g. with differing orbital radii. In addition, the angularity can also be realized so as to be settable. It may be the case that such adjustability of the coupling-body angle may be more easily realized than alteration of the length of a lever arm length.

A corresponding angular arrangement, in particular in the form of diverging or converging coupling bodies, can also be used to generate an axial force upon a respective rotor, which force, besides being used as an effective force perpendicular to the rotor axis, as mentioned previously and explained in greater detail in the following, can also be used for compensating other forces or altering position.

For the purpose of controlling the wave energy converter, or the rotor and the acting forces, a control device is provided. As control variables, the latter uses the adjustable second torque of the at least one rotor and/or the adjustable first torque, e.g. through the adjustment of the at least one coupling body, i.e. the first torque. In addition to the machine state variables, with acquisition of the rotor angle and/or coupling-body adjustment, it is also possible to use the currently prevailing local flow field of the wave. This can be determined by means of corresponding sensors. In this case, these sensors can be disposed so as to rotate concomitantly on parts of the rotor and/or on the housing and/or independently of the machine, preferably positioned in front of or behind the latter. Local, regional and global acquisition of a flow field, wave propagation direction, orbital flow and the like can be provided, wherein “local” acquisition may relate to the conditions existing directly at a component of a wave energy converter, “regional” acquisition may relate to acquisition on component groups or a discrete system, and “global” acquisition may relate to the system as a whole or to a corresponding converter park. This makes it possible to perform predictive measurement and forecasting of wave states. Measured variables may be, for example, the flow velocity and/or flow direction and/or wave height and/or wave length and/or period and/or wave propagation velocity and/or machine motion and/or holding moments of the coupling body adjustment and/or adjustment moments of the coupling bodies and/or the rotor moment and/or forces transmitted into a mooring.

Preferably, the currently existing incident flow conditions at the coupling body can be determined from the measured variables, such that the coupling body and/or the second torque can be set accordingly, in order to achieve the higher-level feedback control objectives.

Particularly preferably, however, it is provided that the entire propagating flow field is known from appropriate measurements upstream from the machine or a park of a plurality of machines. Through appropriate calculations, therefore, it is possible to determine the subsequent local incident flow against the machine, thereby enabling the machine to be controlled in a particularly accurate manner. By means of such measurements it would be possible, in particular, to implement a higher-order machine control system that, for example, aligns itself to a main component of the incoming wave. It is thereby possible to achieve particularly robust operation of the machine.

Further advantages and designs of the invention are given by the description and the accompanying drawing.

It is understood that the above-mentioned features and those yet to be explained in the following can be applied, not only in the respectively specified combination, but also in other combinations or singly, without departure from the scope of the present invention.

The invention is represented schematically in the drawing, on the basis of exemplary embodiments, and is described in detail in the following with reference to the drawing.

### DESCRIPTION OF THE FIGURES

FIG. 1 shows a side view of a wave energy converter, having a rotor that has two lift devices, and illustrates the angle of attack γ and the phase angle Δ between the rotor and an orbital flow.

FIG. 2 shows resultant incident flow angles a₁ and a₂, and resultant forces at the coupling bodies of the rotor from FIG. 1.

FIG. 3 illustrates a method for influencing an effective force on the basis of the curves of phase angle, angle of attack, moment and force.

FIG. 4 shows a side view of a wave energy converter having a rotor of large radial extent, with differing incident flow on the coupling bodies, and resultant forces.

FIG. 5 shows a perspective view of two rotors for converting energy from a wave motion, having disk-shaped rotor bases.

FIG. 6 shows a perspective view of a wave energy converter having a rotor for converting energy from a wave motion, having lever arms for attaching coupling bodies.

FIG. 7 shows a perspective view of a wave energy converter having a rotor for converting energy from a wave motion, having a rotor base realized as a generator rotor.

FIG. 8 shows a perspective view of rotors for converting energy from a wave motion, having oblique coupling bodies.

FIG. 9 shows a side view and a top view of a further wave energy converter for converting energy from a wave motion, having oblique coupling bodies.

FIG. 10 shows a perspective view of a wave energy converter having a rotor for converting energy from a wave motion, having a double-sided coupling body arrangement.

FIG. 11 shows a perspective view of a further wave energy converter having a rotor for converting energy from a wave motion, having a double-sided coupling body arrangement.

FIG. 12 shows a perspective view of a further wave energy converter having a rotor for converting energy from a wave motion, having a double-sided coupling body arrangement.

FIG. 13 shows a perspective view of a wave energy converter having a rotor for converting energy from a wave motion, having a double-sided coupling body arrangement on a holding structure.

FIG. 14 shows a side view of a wave energy converter having a rotor for converting energy from a wave motion, on a holding structure and with an anchoring device.

FIG. 15 shows a perspective view of a plurality of wave energy converters for converting energy from a wave motion, on a holding structure.

FIG. 16 shows a perspective view of a plurality of wave energy converters for converting energy from a wave motion, on a holding structure, with a double-sided coupling body arrangement.

FIG. 17 shows a perspective view of a plurality of wave energy converters for converting energy from a wave motion, on a holding structure, with, in part, a double-sided coupling body arrangement.

FIG. 18 illustrates, in a side view, the disposition of sensors on and around a wave energy converter having a rotor for converting energy from a wave motion, on a holding structure.

FIG. 19 illustrates, in a perspective view, possible shape modifications on coupling bodies.

### DETAILED DESCRIPTION OF THE DRAWINGS

In the figures, elements that are the same or have the same function are denoted by identical references. For reasons of clarity, explanations are not repeated.

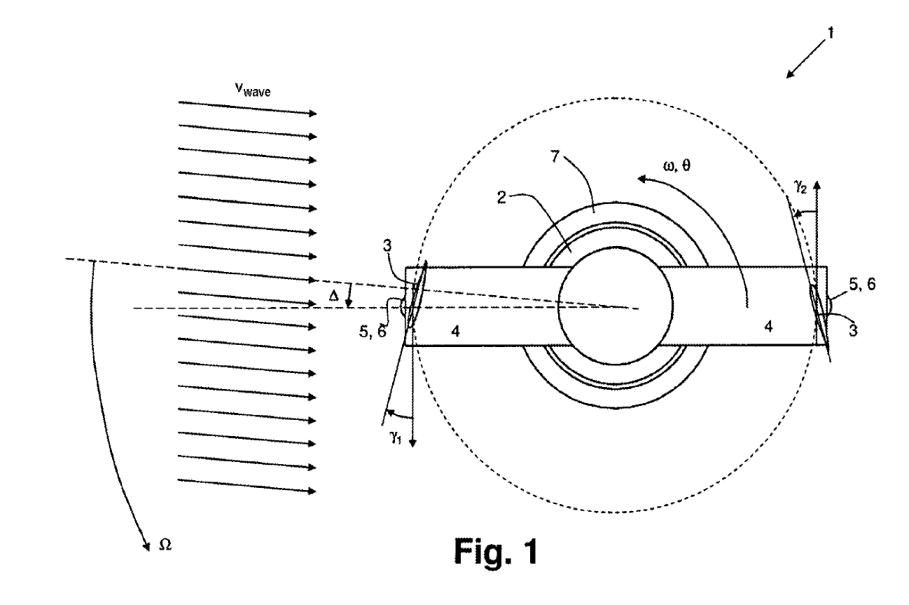

Represented in FIG. 1 is a wave energy converter 1, which has a rotor 2,3,4 that has a rotor base 2, a housing 7 and two coupling bodies 3 that are each fastened to the rotor base 2 in a rotationally fixed manner via lever arms 4. The rotor 2,3,4 is intended to be disposed beneath the water surface of a body of water that has waves—for example, an ocean. It is intended that its rotation axis be oriented largely horizontally, and largely perpendicularly in relation to the current direction of propagation of the waves of the body of water that has waves. In the example shown, the coupling bodies 3 are realized as lift profiles. It is intended in this case that deep-water conditions exist, in which, as explained, the orbital paths of the water molecules are largely circular. Preferably in this case, the rotating components of the wave energy converter are provided with a largely neutral lift, in order to avoid a preferred position.

The coupling bodies 3 are realized as lift devices and disposed at an angle of 180° in relation to each other. Preferably, the lift devices are mounted close to their pressure point, in order to reduce rotation moments upon the lift devices that occur during operation, and thereby to reduce the demands on the mounting and/or on the adjustment devices.

The radial distance between the suspension point of a coupling body and the rotor axis is 1 m to 50 m, preferably 2 m to 40 m, particularly preferably 4 m to 30 m, and quite particularly preferably 5 m to 20 m.

Additionally represented are two adjustment devices 5 for adjusting the angles of attack γ₁ and γ₂ of the coupling bodies 3 between a foil chord and a tangent. The two angles of attack γ₁ and γ₂ are preferably oriented in opposite directions and preferably have values from −20° to 20°. Greater angles of attack may also be provided, however, particularly when the machine is started up. Preferably, the angles of attack γ₁ and γ₂ can be adjusted independently of each other. The adjustment devices may be, for example, electric motor type adjustment devices—preferably having stepping motors—and/or hydraulic and/or pneumatic components.

In addition, the two adjustment devices 5 may each have a sensor system 6 for determining the current angles of attack γ₁ and γ₂. A further sensor system, not represented, can determine the rotational state of the rotor base 2.

The orbital flow flows against the wave energy converter 1 at an incident flow velocity v_{wave}. The incident flow in this case is the orbital flow of sea waves, the direction of which changes continuously. In the case represented, the rotation of the orbital flow is oriented anti-clockwise, and so the associated wave propagates from right to left. In the monochromatic case, the incident flow direction in this case changes at the angular velocity O=2 p f=const., wherein f represents the frequency of the monochromatic wave. In multichromatic waves, by contrast, O is subject to a time change, O=f(t), since the frequency f is a function of time, f=f(t). It is provided that the rotor 2,3,4 rotates in synchronism with the orbital flow of the wave motion, at an angular velocity ω, the term synchronism to be understood in the sense previously described. In this case, for example, Ω≈ω. A value or a value range of an angular velocity ω of the rotor is thus specified on the basis of an angular velocity O of the orbital flow, or is adapted to the latter. A constant feedback control or a short-time, or short-term, adaptation may be effected in this case.

As explained in greater detail below, a first torque acting upon the rotor 2,3,4 is generated as a result of the action of the flow, having the flow velocity v_{wave}, upon the coupling bodies. It is furthermore provided that a preferably variable second torque, in the form of a resistance, i.e. a braking moment, or an acceleration moment, can be applied to the rotor 2,3,4. Means for generating the second torque are disposed between the rotor base 2 and the housing 7. It is preferably provided in this case that the housing 7 is the stator of a directly driven generator, and the rotor base 2 is the generator rotor of this directly driven generator, the mounting, windings, etc. of which are not represented. As an alternative to this, however, other drive train variants may also be provided, in which the means for generating the second moment, in addition to comprising a generator, also comprise a transmission and/or hydraulic components such as, for example, pumps. The means for generating the second moment may comprise, additionally or, also, exclusively, a suitable brake.

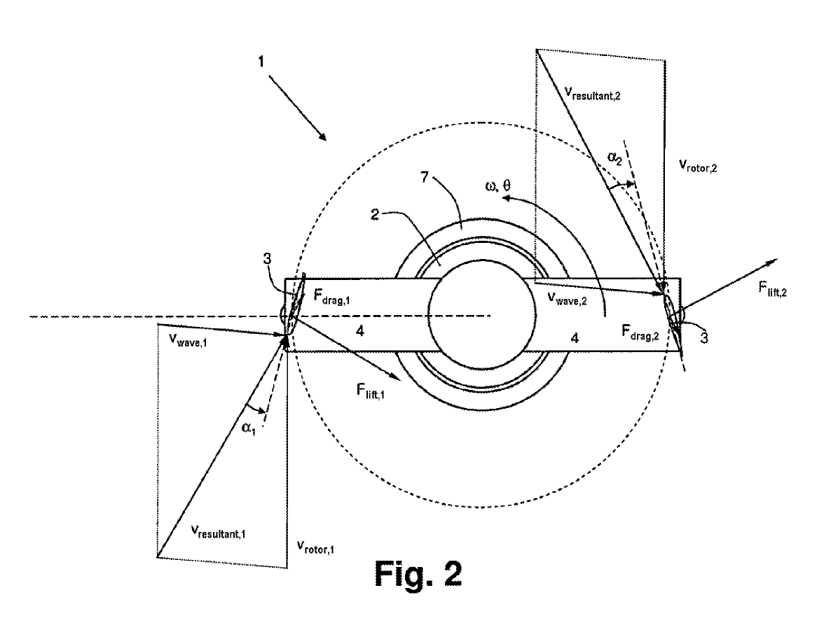

Between the rotor orientation, which is indicated by a lower broken line running through the rotor axis and the center of the two adjustment devices 5, and the direction of the orbital flow, which is indicated by the upper broken line running through one of the velocity arrows v_{wave}, there is a phase angle Δ, the magnitude of which can be influenced by the setting of the first and/or second torque. A phase angle of −45° to 45°, preferably of −25° to 25°, and particularly preferably of −15° to 15°, appears in this case to be particularly advantageous for generating the first torque, since in this case the orbital flow v_{wave} and the incident flow are oriented largely perpendicularly in relation to each other, owing to the spin vᵣₒₜₒᵣ (see FIG. 2), causing the rotor moment to be maximized. Maintaining the required synchronism, Δ≈const., wherein—as already described above—a swing around a mean value of Δ is also understood to be synchronous within the scope of the invention. In FIG. 1 and the subsequent figures, the coupling bodies are represented in a merely exemplary manner for the purpose of defining the various machine parameters. In operation, the angles of attack of the two coupling bodies are preferably realized in a manner opposite to that represented. The coupling body on the left in FIG. 1 would then be adjusted inward, and the coupling body on the right in FIG. 1 would be adjusted outward.

FIG. 2 shows the resultant incident flow conditions and the forces ensuing at the coupling bodies that produce a rotor torque. It is assumed in this simplified case that the flow is uniform in nature, and is of the same magnitude and the same direction, over the entire rotor cross section. However, particularly for rotors of large radial extent, it may be the case that the various coupling bodies 3 of the rotor 2,3,4 are located at differing positions relative to the wave, resulting in a locally different incident flow direction. This can be compensated, however, for example by means of an individual setting of the respective angle of attack γ.

FIG. 2 shows the local incident flows at the two coupling bodies caused by the orbital flow (v_{wave,i}) and by the spin (v_{rotor,i}), the incident flow velocity (v_{resultant,i}) that results as a vector sum from these two incident flows, and the ensuing incident flow angles a₁ and a₂. Also derived are the ensuing lift and drag forces F_{lift,i} and F_{drag,i} at both coupling bodies, which are dependent both on the magnitude of the incident flow velocity and on the incident flow angles a₁ and a₂, and therefore also on the angles of attack γ₁ and γ₂, and which are oriented perpendicularly and parallel, respectively, to the direction of v_{resultant,i}.

For the case represented, the two lift forces F_{lift,i} result in an anticlockwise rotor torque, and the two drag forces F_{drag,i} result in a rotor torque of lesser magnitude in the opposite direction (i.e. in the clockwise direction). The sum of the two rotor torques produces a rotation of the rotor 1, the velocity of which can be set through the reaction torque, by means of the adjustable second torque.

If the synchronism required according to the invention is achieved with Δ≈const., then it is immediately evident from FIG. 2 that, for monochromatic cases, in which the value of the flow v_{wave,i} and the angular velocity O remain constant, the incident flow conditions of the two coupling bodies 3 do not alter over the rotation of the rotor. This means that, with constant angles of attack γ, a constant rotor moment is generated that can be picked up with a constant second torque of a corresponding generator.

From the forces acting on the coupling bodies, in addition to a rotor moment, a resultant rotor force is also obtained as a result of vectorial addition of F_{lift,i}, F_{drag,i}, F_{lift,2} and F_{drag,2}. This rotor force acts as a bearing force upon the housing, and must be supported accordingly if displacement of the housing is not wanted. While the rotor moment remains constant, assuming the same incident flow conditions (v_{wave,i}, Δ, Ω, ω, α₁, α₂, γ₁, γ₂=const.), this applies only to the magnitude of the resultant rotor force. Owing to the continuously changing flow direction of the orbital flow and the synchronous rotor rotation, the direction of the rotor force changes accordingly.

As well as influencing the rotor moment by adjustment of the angle of attack γ and/or adjustment of the phase angle Δ, it is also possible to influence the magnitude of this rotor force by changing the angle of attack γ (as a result of which the incident flow angles a change), by changing the rotor angular velocity ω and/or the phase angle Δ—for example, by changing the generator moment applied as the second moment (as a result of which vᵣₒₜₒᵣ changes) and/or by a combination of these changes. Preferably, in this case, the synchronism described in the introduction is maintained.

Through appropriate adjustment of these control variables per revolution, and an associated alteration of the rotor force, the wave energy converter can be moved in any radial direction. It is to be noted in this connection that the representation in FIG. 2 includes only an orbital flow that is directed perpendicularly in relation to the rotation axis and that does not have any flow components in the direction of the plane of the drawing. If, contrary to this, as is the case under real conditions, the rotor receives an oblique incident flow, the result is a rotor force that, in addition to having a force component directed perpendicularly in relation to the rotor axis, also has an axial force component. The latter is due to the fact that the hydrodynamic drag force of a coupling body is directed in the direction of the local incident flow.

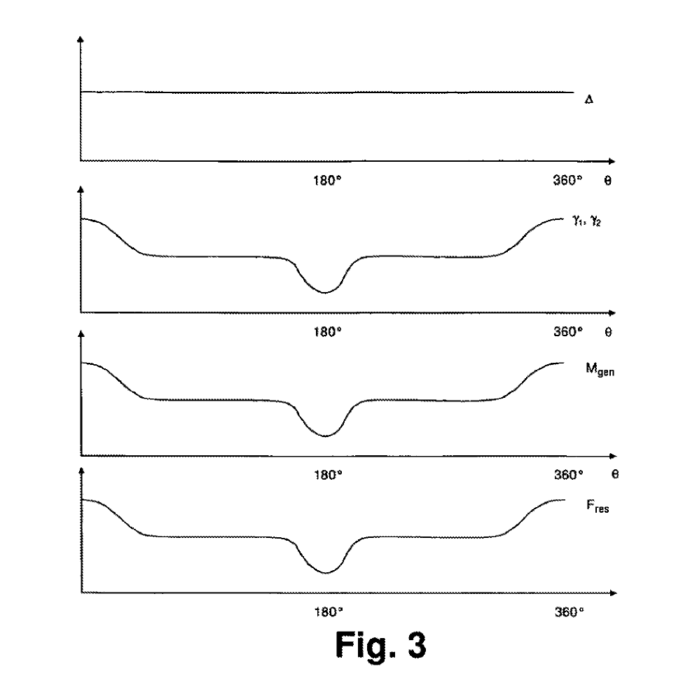

A possible procedure for influencing the rotor force during a revolution is represented qualitatively in FIG. 3. It is assumed in this case that, while maintaining a strict synchronism (Δ=const.) and, firstly, for simplicity, also for monochromatic wave states, with the wave energy converter 1 from FIG. 1 to be displaced to the right in the horizontal direction, the rotor receives incident flow from the left for θ=0, and the resultant rotor force is directed approximately in the direction of incident flow. For different directions of the rotor flow, the procedure described in the following can be adapted in an appropriate manner.

The individual graphs of FIG. 3 show, respectively, a phase angle Δ, a first and a second angle of attack γ₁ and γ₂, a second moment—represented here as a generator moment M_{gen}—and an effective force Fᵣₑₛ, as a function of a phase angle θ.

For this purpose, for example in a range of approximately 320°<θ<40°, the resultant forces at the coupling bodies are maximized by large angles of attack γ, thereby producing a large resultant force upon the rotor in the direction of flow (to the right). In order to achieve strict synchronism, the second torque, in the form of the generator moment, is likewise increased in an appropriate manner, since the large incident flow angles a also produce large rotor moments, which would otherwise result in acceleration of the rotor, and consequently in a change in the phase angle Δ. For the range of approximately 140°<θ<220°, in which the incident flow is effected from the right—the rotor force is therefore largely directed to the left—these values are reduced accordingly, such that the force directed to the left is correspondingly less. For the intermediate regions with incident flows from below and above, the two values are set to a mean value, such that, here, the upwardly and downwardly directed forces largely cancel each other out over a revolution. Overall, therefore, the result per revolution is a displacement of the wave energy converter 1 by a corresponding distance to the right, in the horizontal direction.

In summary, it may be stated that the rotor force is influenced, expediently, when it is oriented in or contrary to the direction in which, for example, a displacement is to be achieved. In this case, in particular in order to take account of locally varying flow conditions (v_{wave} may differ, particularly in the case of large rotor extents or in the case of multichromatic flow conditions), the two angles of attack γ may be appropriately altered independently of each other, the generator moment then being appropriately matched to the respectively resultant rotor moment, in order to achieve absolute synchronism. This can affect the line of action of the rotor force, and consequently the vibrational behavior of the rotor 1.

A similar effect would be obtained if one of the two changes in FIG. 3 were omitted. Even then, there would be a corresponding overall displacement of the system, but at reduced speed.

Similarly, the wave energy converter machine can also be displaced vertically or in any spatial direction perpendicular to the rotor axis. Such a method can also be used to compensate forces superposed on the orbital flow—for example, resulting from marine currents or the like—and to prevent the machine from drifting. In particular, this also reduces the requirements for anchoring. Moreover, it may be provided to utilize the generation of directed resultant forces in order to stabilize the machine system as a whole and/or to compensate forces.

There is a similar method for cases of multichromatic waves, except that, in this case, the changes need not be effected periodically, since the direction of flow does not change periodically. However, the current direction of flow—particularly preferably, usually the local incident flow v_{wave} of the individual coupling bodies 3—can be detected by means of appropriate sensor systems, such that corresponding open-loop/closed-loop control of the machine is possible, in order to generate directed resultant forces.

If maintenance of absolute synchronism is dispensed with and the phase angle Δ is therefore allowed to fluctuate about a mean value, displacement of the rotor through influencing of the resultant rotor force can also be achieved by an appropriate adjustment of either only the first or only the second torque.

If, for example at a constant second torque, at least one of the two angles of attack γ is increased, this results in greater forces F_{lift} and F_{drag} at the at least one of the two coupling bodies 3 and, associated with this, the resultant rotor force and a greater rotor moment. Since the second torque is held constant, this results in an acceleration of the rotor, and consequently in a change in the phase angle Δ. A reduction in the angle of attack γ results in reduced forces and, in the case of a constant second torque, in braking, and consequently in a change in the phase angle Δ in the opposite direction.

A fluctuation of the phase angle Δ about a mean value Δ=0° is provided. In order to fulfill this expanded synchronism term, it is provided that the phase angle Δ can be varied in a bandwidth between −90°<Δ<90°.

If, as a result of particular operational circumstances, a situation occurs in which the phase angle Δ does not fulfill this default, the preceding signs of the angles of attack γ of the coupling bodies can be interchanged, such that the aforementioned phase angle can again be achieved for subsequent operation.

Through appropriate selection of the change intervals over the rotor revolution, it is therefore also possible to influence position by selectively varying the resultant rotor force merely by changing the angles of attack γ.

The same applies to changing the second moment with constant angles of attack γ—i.e. a constant first moment. This also results in a change in the phase angle Δ and the rotor force, which can be varied in an appropriate manner.

Intermediate solutions between the cases described may also be advantageous, with the adjustment of only one of the torques and a common adjustment of both variables in order to influence the rotor force while, at the same time, maintaining the requirement for synchronism. For real multichromatic sea states, in particular, mixed states will tend to ensue in actual situations if both variables are influenced.

It is therefore possible to maintain the required synchronism, in particular also for multichromatic sea states, even in the case of rotors without settable angles of attack γ or without a settable second torque. It is possible in this case to use a rotor having fixedly set angles of attack γ, whose phase angle Δ and/or effective force is effected by adapting only the second moment. An advantage of this system is the reduction in the system complexity, owing to the absence of active adjusting elements. The angles of attack γ in this case are preferably set in opposite directions—the one coupling body is adjusted (pitched) inward, while the other coupling body is pitched outward—(in respect of amount) to a fixed value of 0° to 20°, preferably from 3° to 15°, and particularly preferably from 5° to 12°, and most particularly preferably from 7° to 10°.

Alternatively, it may also be provided that only one of the two coupling bodies has an adjusting device, while the other coupling body 3 is mounted with a fixed angle of attack γ.

Alternatively, it is also possible to use a rotor in which the second torque constant is set to a mean value, whose phase angle Δ and/or rotor force is effected while maintaining the required synchronism by appropriately changing the angles of attack γ.

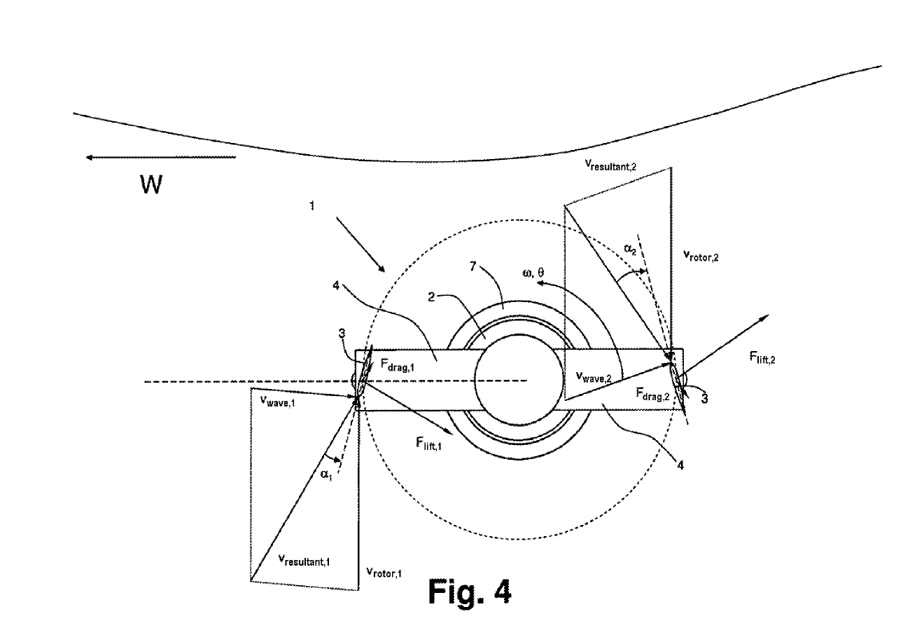

In order to illustrate the effect of rotor extents that are large relative to the wave length, FIG. 4 shows a wave energy converter 1 in which the diameter is so great that the direction of incident flow v_{wave} differs between the two coupling bodies 3. The rotor in this case is rotating anticlockwise, and the direction of wave propagation is oriented from right to left and denoted by W. In this case, under the wave minimum the water particles move largely horizontally, from left to right. The coupling body on the left is still disposed slightly ahead of the minimum, such that v_{wave,1} faces slightly downward and is not yet completely horizontal in its orientation (same incident flow as in FIG. 2).

In contrast with this, the minimum has already passed the position of the right-side coupling body, such that, here, the incident flow v_{wave,2} is already effected obliquely from below. This results in changed incident flow conditions, with a different incident flow velocity v_{resultant,2} and a different incident flow angle a₂ than in FIG. 2, in which it was assumed that the direction of incident flow is identical on both coupling bodies. Consequently, the magnitude and the direction of action of the two forces F_{lift,2} and F_{drag,2} on this coupling body also change, and consequently the rotor force and the rotor moment also change accordingly.

A similar effect is obtained as a result of the exponential depth dependence of the flow velocity of the orbital flow. If the rotor from FIG. 2 is oriented vertically (rotated by 90°), then, in the case of rotor extents that are large relative to the wave length, the lower coupling body 3 is subjected to lesser flow velocities than the upper coupling body 3. This effect also correspondingly affects the rotor force and the rotor moment.

However, through appropriate adaptation of the angles of attack γ—i.e. setting of the first torque—and of the second torque, both effects can be used, or compensated, in an appropriate manner to continue to ensure synchronism even under such conditions and/or to influence the rotor force in an appropriate manner.

For the case of large rotor radii with an unequal incident flow on the coupling bodies, the phase angle Δ is defined as the angle between the connecting line of the coupling body 3 facing toward the orbital flow and the center of rotation and the radial direction of incident flow on the rotor center.

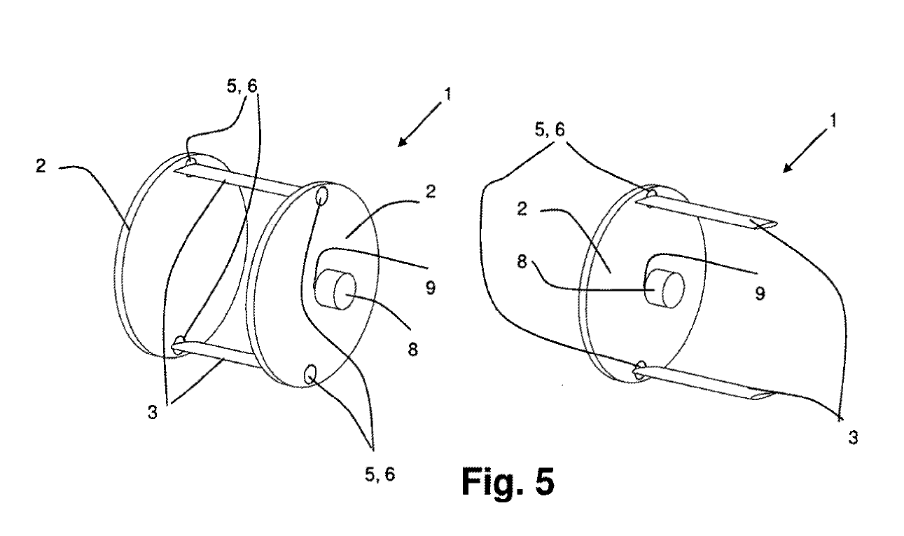

Two embodiments of the wave energy converter 1 are represented in FIG. 5. They each have two coupling bodies 3 mounted on one or both sides of a rotor base 2. The coupling bodies may be provided with an adjustment system 5, which is used to actively adjust the angle of attack γ of the coupling bodies. If the coupling bodies are mounted on both sides, the second side can be rotatably mounted; alternatively, it is also possible for an adjustment system 5 to be attached on both sides. In addition, sensors 6 may be provided, for determining the angle of attack γ. A sensor, not represented, may also be provided for determining the rotary position θ of the rotor base 2.

On the rotor base 2, acting on a rotor shaft 9 there is an energy converter 8 that may comprise, for example, a directly driven generator.

In the context of this document, rotors that have the coupling body or coupling bodies disposed on only one side of the rotor base 2 are all referred to by the general term one-sided rotors. Two-sided rotors, accordingly, have a rotor base 2 that is two-sided in respect of their plane of rotation, at least one coupling body being attached to each side of the two-sided rotor base 2.

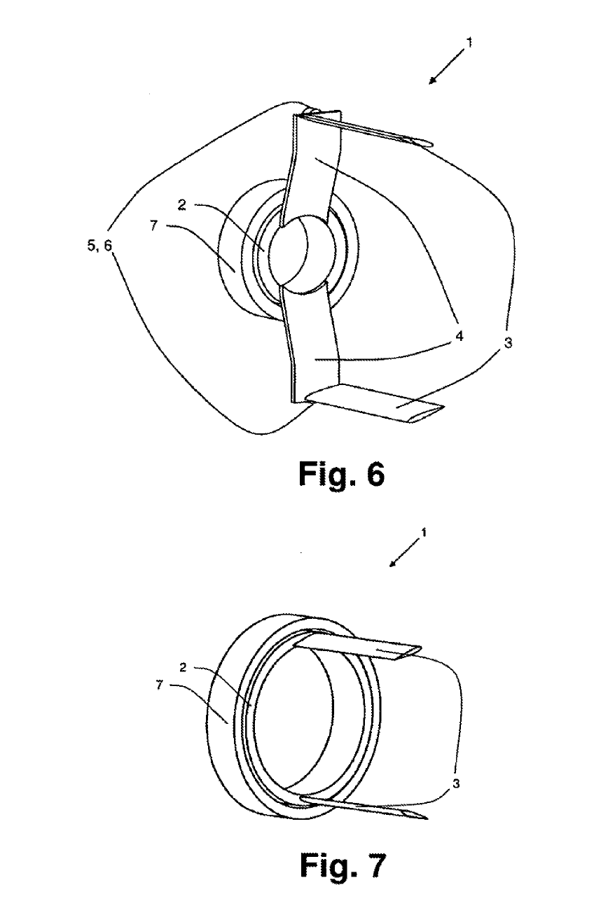

FIG. 6 shows a perspective representation of a wave energy converter 1 having a one-sided rotor, in which the coupling bodies 3 are mounted, via lever arms 4, on a rotor base 2 that is mounted in a housing 7. In this case, it may be provided, advantageously, that the housing 7 and the rotor base 2 are the stator and generator rotor of a directly driven generator. A rotor shaft 9 as in FIG. 6 is no longer included here, thereby achieving savings in structural costs. The lever arms 4 may be realized so as to be adjustable in length.

FIG. 7 shows an alternative wave energy converter 1 having a one-sided rotor 2,3, in which the coupling bodies 3 are coupled directly to a rotor base 2 realized as a generator rotor of a directly driven generator. Adjustment systems, for adjusting the coupling bodies 3 and sensors for state monitoring/position determination, are not represented, but may be provided. Here, likewise, there is no shaft 9.

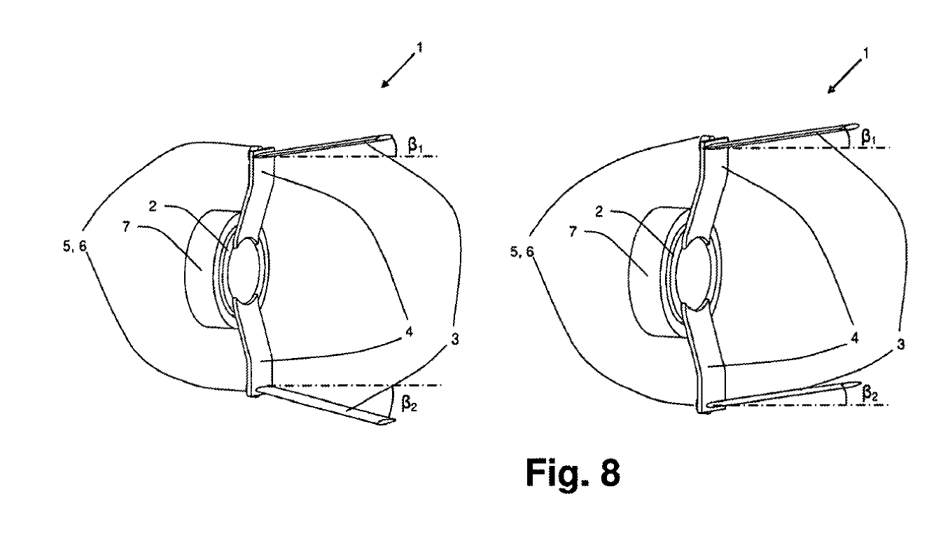

FIG. 8 shows a further wave energy converter 1 having a rotor 2,3,4 with coupling bodies 3, in which the coupling bodies 3 are not oriented parallel to the rotation axis of the rotor 1, but have a tilt in the radial direction, such that angles β₁ and β₂ ensue relative to the rotor axis. This tilt can be effected such that it is different for each coupling body 3 and can be set independently, and can be superposed on any existing adjustment of the angle of attack γ.

Such a coupling-body adjustment offers the advantage of a more broad-banded machine behavior. Thus, a machine having coupling bodies disposed parallel to the rotation axis is optimally designed for a certain wave state, having a corresponding wave height and period, and in the ideal case it can optimally extinguish this wave. What occurs in reality, however, is a great difference in wave states, including, in particular, (multiple) superpositions of differing wave states.

The rotor 1 according to FIG. 7 in this case combines, as it were, various machine radii in one machine, such that a part of the rotor is always optimally designed for the current wave state. Particularly in combination with a possibility for adjusting this angle, this results in a particularly advantageous rotor having superior properties.

As represented on the left in FIG. 8, there is also the possibility to adjust all coupling bodies 3 outward, or as on the right in FIG. 8, to effect the adjustment, preferably, in opposite directions, as also provided for the angles of attack γ. Not represented is the third possibility, in which the coupling bodies are all adjusted inward; this possibility may likewise be advantageous.

A tilted adjustment of the coupling bodies in the radial direction may also be used, advantageously, to influence the direction of the rotor force, or effective force. Since the hydrodynamic lift is oriented perpendicularly in relation to the local incident flow, adjustment of the coupling body in the radial direction, in addition to producing a rotor force component directed perpendicularly in relation to the rotation axis, also produces an axial rotor force component. The latter can be used, advantageously, to stabilize and/or to move the rotor.

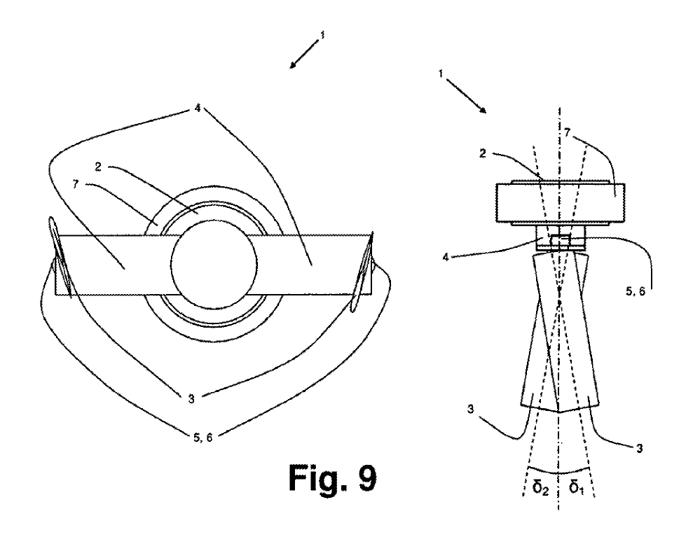

FIG. 9 shows two views of a further possibility, in which the coupling bodies 3 are not parallel to the rotation axis. Here, an axial tilt is produced, such that angles d₁ and d₂ ensue relative to the rotor axis, which angles may be settable by means of corresponding adjustment devices 5. Such a tilt corresponds, to a certain extent, to a sweep such as that also used in the case of aircraft wings, whereby the corresponding advantages, which are known per se, can be achieved.

Also provided, advantageously, is a combination of the deviations of the orientation of the coupling bodies from an alignment parallel to the rotation axis, in particular superposed on the angle of attack γ of the coupling bodies 3, which deviations are represented in FIGS. 8 and 9.

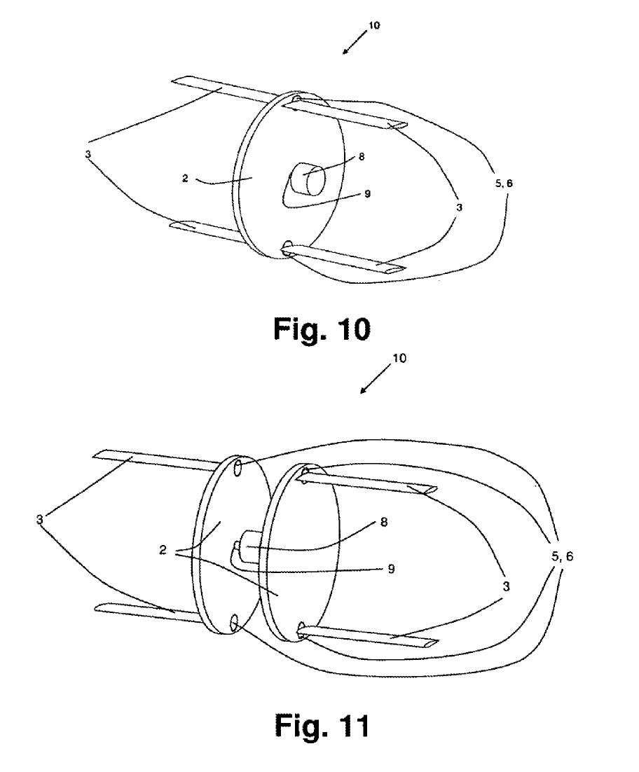

FIG. 10 shows a particularly preferred design of a wave energy converter 10 having a rotor. The latter is characterized in that coupling bodies 3 are disposed on both sides of the rotor base 2. As has been mentioned, such rotors are referred to by the term “two-sided rotor”. The properties and features mentioned previously in the explanations relating to FIGS. 1 to 9 can also be applied and assigned, singly or in combination, to this wave energy converter having a two-sided rotor. This means that an angle of attack γ of each coupling body 3 and/or the drag and/or the phase angle Δ may be settable, the operational control system is directed toward (a high degree of) synchronism, and/or, through appropriate adjustment of the angles of attack γ, β and/or d and/or of the second torque and/or of the phase angle Δ, the resultant rotor force can be varied over the rotor rotation so as to produce a resultant force that can be used to displace the wave energy converter and/or to compensate superposed forces such as, for example, those resulting from flows, and/or for selective excitation of vibrations and/or for stabilizing the wave energy converter.

Advantageously, it may additionally be provided that the free ends of the coupling bodies are each mounted in a common base, as represented for a one-sided rotor in FIG. 5.

If the direction of wave propagation of a monochromatic wave is aligned perpendicularly in relation to the rotation axis of the rotor, this has the result that, in the ideal case, the coupling bodies, disposed next to each other in pairs in each case, are subjected to absolutely identical incident flow conditions. For this case, the angles of attack γ of these adjacently disposed coupling bodies may preferably have identical settings. If, in real operation, there is a difference in the incident flow on to the two halves of the rotor, then the angle of attack of each coupling body 3 can be set individually, so as to optimize the local incident flow.

The superposition of the forces of all coupling bodies 3 in this case produces a rotor moment and a rotor force that are each dependent on the local incident flow condition and that can be changed continuously by adaptation of the angles of attack γ, β and/or δ and/or of the drag. Therefore, (partial) synchronism conditions and the generation of resultant forces, explained in connection with FIG. 3, can also be applied to such a wave energy converter having a two-sided rotor.

As compared with a wave energy converter 1 having a one-sided rotor, as in the previous illustrations, with a wave energy converter 10 having a two-sided rotor it is also possible to achieve a rotation of the wave energy converter 10 about an axis that is oriented perpendicularly in relation to the rotor axis. In this case, the wave energy converter 10 can be rotated about its vertical axis during operation by differentially influencing the angles of attack γ, β and/or δ of the coupling bodies 3 and/or by adapting the drag. This may be used, particularly advantageously, to align the wave energy converter 10 such that the orientation of its rotor axis is largely perpendicular to the currently existing direction of wave propagation.

For this purpose, the strategies explained in connection with FIG. 3 for generating directed resultant forces can be applied to this wave energy converter 10 having a two-sided rotor, in such a manner that the two rotor sides are controlled by open-loop/closed-loop control, for example, in differing directions. Possible strategies for rotating a wave energy converter having a two-sided rotor about the vertical axis may be inferred directly by persons skilled in the art.

FIG. 11 shows a further design of a wave energy converter 10 having coupling bodies 3 disposed on both sides. In the case of this wave energy converter, the rotor base 2 is divided into two (partial) rotor bases 2, with a rotor shaft 9 disposed between them and, disposed on the rotor shaft, an energy converter 8, which may comprise, for example, a generator and/or a transmission. Since the two rotor sides are connected to each other via the shaft, in a largely torsionally stiff manner if expedient, and therefore rotate synchronously, this configuration is understood to be a two-sided rotor, to which the properties described in connection with FIG. 10 likewise apply. Also understood as a two-sided rotor is an assembly of two one-sided rotors joined in such a manner that the two rotors have largely the same orientation during operation.

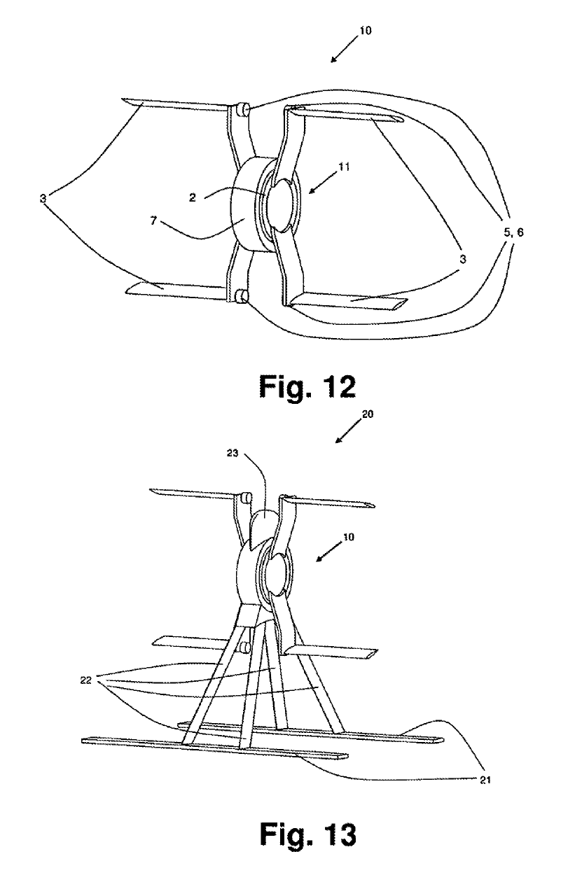

FIG. 12 shows a further embodiment of a wave energy converter 10 having a two-sided rotor 10. This is a preferred embodiment, in which the energy converter is realized as a directly driven generator 11 that, as an integral constituent part of the wave energy converter 10, with its stator constitutes the rotationally fixed housing 7 of the wave energy converter, and in which the coupling bodies 3 are directly coupled, via lever arms, to the generator rotor 2 of the generator 11, which generator rotor acts as a rotor base 2. The wave energy converter 10 of this design thus has a particularly compact structural form, in which structural costs are minimized because of the absence of a shaft 9. This embodiment, likewise, can be combined with the previously described embodiments and operating strategies.

FIG. 13 shows a wave energy converter 20 that comprises further elements in addition to a wave energy converter 10 according to FIG. 12. These elements, in particular, are damping plates 21, which are connected in a largely rigid manner, via a frame 22, to the housing 7, or to a stator of a directly driven generator. The damping plates 21 are located in greater depths of water than the rotor. At these greater depths of water, the orbital motion of the water molecules that is caused by the wave motion is reduced significantly, such that the damping plates 21 have the effect of supporting, or stabilizing, the wave energy converter 20. In this case, during operation, stabilization of the wave energy converter 20 according to the strategies described above can additionally be superposed with selective influencing of the resultant rotor force.

Such stabilization is advantageous in order to keep the rotation axis stationary in a first approximation. Without such stabilization, in an extreme case the rotor forces would cause the rotation axis to orbit, offset in phase, with the orbital flow, which would fundamentally alter the incident flow conditions of the coupling bodies 3. This would negatively affect the functionality of the wave energy converter. It is to be understood, however, that a wave energy converter may also be correspondingly stabilized by other means, which need not comprise damping plates.

The damping plates are represented, by way of example, as being horizontal. Also considered as advantageous, however, are configurations in which the damping plates have a different orientation. For example, the two plates could be disposed with a 45° tilt in opposite directions, such that they enclose with each other an angle of 90°. Other configurations may be deduced by persons skilled in the art. Different damping plate geometries and/or different numbers of damping plates may also be used.

Moreover, it may be provided that the damping plates 21 are adjustable in their angle and/or in their damping effect. The damping effect may be influenced, for example, by changing the fluid permeability. The response behavior of the wave energy converter 20 to the introduced forces can also be influenced by, if need be, cyclically altered damping.

In addition to the damping plates 21, a hydrostatic lift system 23 may be provided, by means of which the immersion depth of the wave energy converter can be set, for example by pumping a fluid in and out. For a stationary case, the lift is then set such that it compensates the weight of the machine and the mooring, less the lift that prevails as a result of immersion in water. Since the rotating parts of the rotor 10 preferably have a largely neutral lift, it is therefore necessary to take account of, in essence, the weights of the housing, frame, damping plates and of a mooring device, which is explained below.

The immersion depth can be easily regulated by small changes in the lift, particularly in combination with a so-called catenary mooring, for example in order to protect the machine against excessive wave states with excessively high content, by moving the machine into greater depths of water, or in order to convey it to the surface for servicing.

The machine control system of the wave energy converter 20 may also be accommodated in the housing of the lift system 23. Moreover, as an alternative to a two-sided rotor 10, one-sided rotors 1 may also be used.

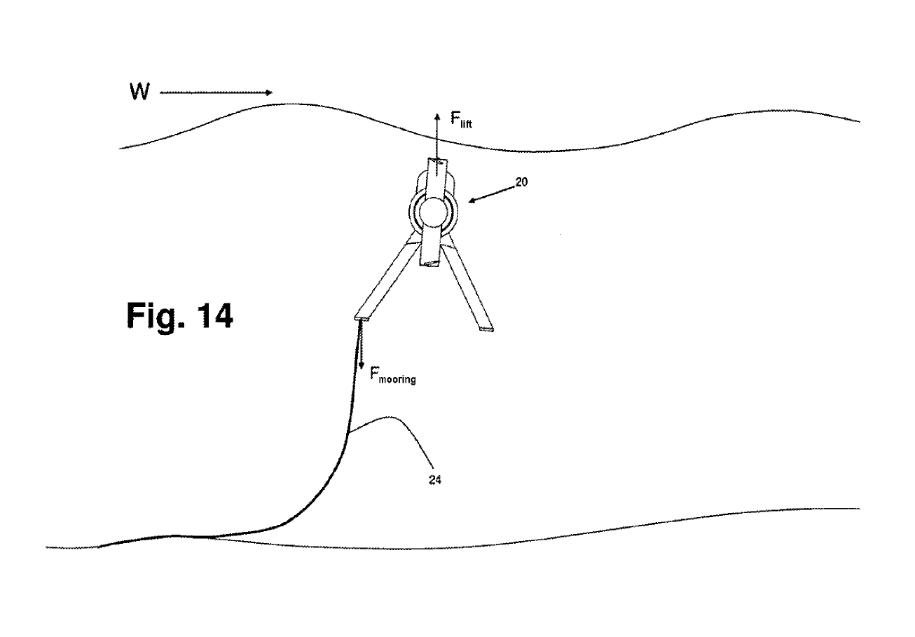

FIG. 14 shows the wave energy converter 20 from FIG. 13, in a body of water having waves, having an anchorage 24 on the seabed, which is preferably effected by means of a mooring, in particular by means of a catenary mooring, but which, alternatively, may also be realized as a rigid anchorage. A direction of wave propagation is denoted by W. The wave energy converter 20 is connected to the seabed via one or more chains and corresponding anchors. Corresponding moorings are typically composed of metal chains and, particularly in their upper region, may also include at least one plastic rope.

The end of the mooring on the wave energy converter side is fastened to the part of the frame 22 that faces toward the incoming wave, and/or to the damping plate 21 that faces toward the incoming wave. As a result of this, a certain self-alignment of the wave energy converter in relation to the direction of wave propagation (weathervane effect) is already achieved. This self-alignment can be supported by corresponding additional, passive (weathervane) and/or active systems (rotor control, azimuth tracking).

Moreover, the combination of lift and anchorage can be used, particularly advantageously, as a support for the generator moment. The figure also shows the forces F_{mooring} (directed largely downward) and F_{lift} (directed largely upward) that are caused by these two systems. In the configuration represented, if a torque is picked up by the drag, a rotation of the wave energy converter in the clockwise direction is induced (in the direction of the rotor 10). The two forces represented generate a torque that is contrary to this rotation and that increases as the tilt of the wave energy converter 20 increases. In addition, tilting of the machine resulting from removal of a generator moment can result in lifting of the mooring, causing F_{mooring} to increase. This has the effect of increasing the supporting counter-moment. In addition, the lift can also be actively altered, in order to increase further the counter-moment for the purpose of stabilizing the wave energy converter.

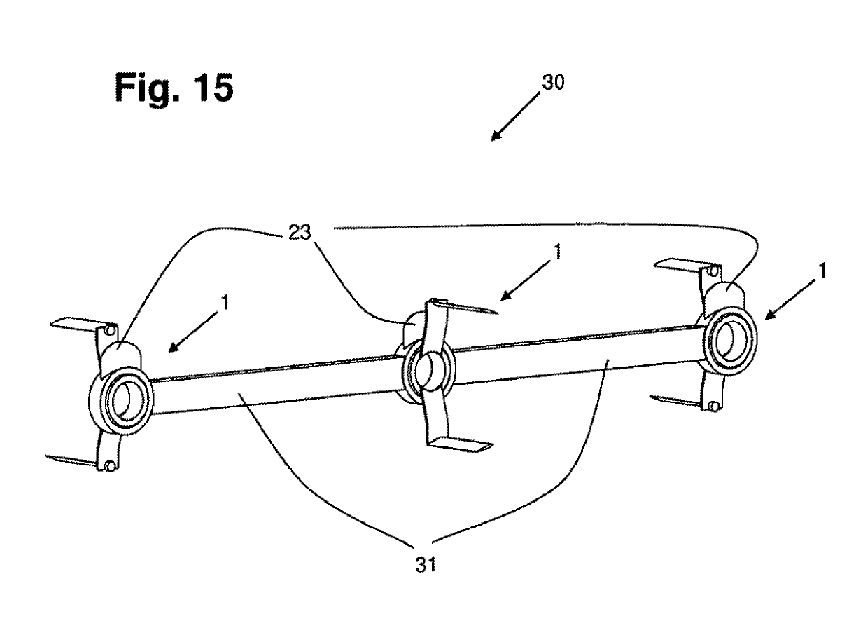

FIG. 15 shows a wave energy converter 30 having three (partial) wave energy converters 1 that have one-sided (partial) rotors according to FIG. 6. In this case, the (partial) wave energy converters are mounted, with their rotor axes largely parallel, in a horizontally oriented frame 31, such that the rotors are disposed under the surface of the water and their rotor axes are oriented largely perpendicularly in relation to the incoming wave. In the case represented, the distance from the first to the last rotor corresponds approximately to the wavelength of the sea wave, such that, for the assumed case of a monochromatic wave, the foremost and the rearmost rotor have the same orientation, while the middle rotor is turned round by 180°. In this case, all three rotors rotate in an anticlockwise direction, i.e. the wave goes over the machine from behind. Wavelengths of sea wave are between 40 m and 360 m, typical waves having wavelengths of 80 m to 200 m.

Since the rotors each receive incident flow from differing directions—they differ in their position under the wave—the direction of the respective rotor force assumes a specific characteristic at each rotor.

This effect can be used to stabilize the wave energy converter 30, in that the individual rotors 1 are controlled by open-loop/closed-loop control, while maintaining a large degree of synchronism, through adjustment of the resistance and/or the angles of attack γ, β and/or d, in such a manner that the resultant rotor forces of the rotors 1 largely cancel each other out.

Mounted on the frame 31 and/or on the rotors, advantageously, are a plurality of lift systems 23, by means of which the immersion depth can be regulated, and by means of which, together with the anchorage, not represented (the latter preferably acts on the part of the frame 31 that faces toward the incoming wave, and can be realized, for example, as a mooring, in particular as a catenary mooring), a counter-moment, which supports the damping moment, can be generated.

The frame 31 in this case may be realized such that the distance between the rotors 1 is settable, such that the machine length can be matched to the current wavelength. Also in consideration, however, are machines that are significantly longer than a wavelength and have a different number of rotors, this resulting in a further improvement in the machine stability as a result of the superposition of the introduced forces.

In addition, for the purpose of further stabilization, damping plates may be provided, which can be disposed at a greater depth of water. Likewise, for the purpose of further stabilizing the machine, in particular in respect of a rotation about the longitudinal axis, lift systems could be disposed on at least one cross-member. Such a cross-member, preferably oriented horizontally, may be disposed at the rear end of the frame.

Furthermore, it may be provided that the frame 31 of the wave energy converter is realized as a floating frame, and that the rotors 1, immersed below the surface of the water and with their rotor axes largely horizontal, are rotatably mounted on the floating frame via a correspondingly realized frame structure.

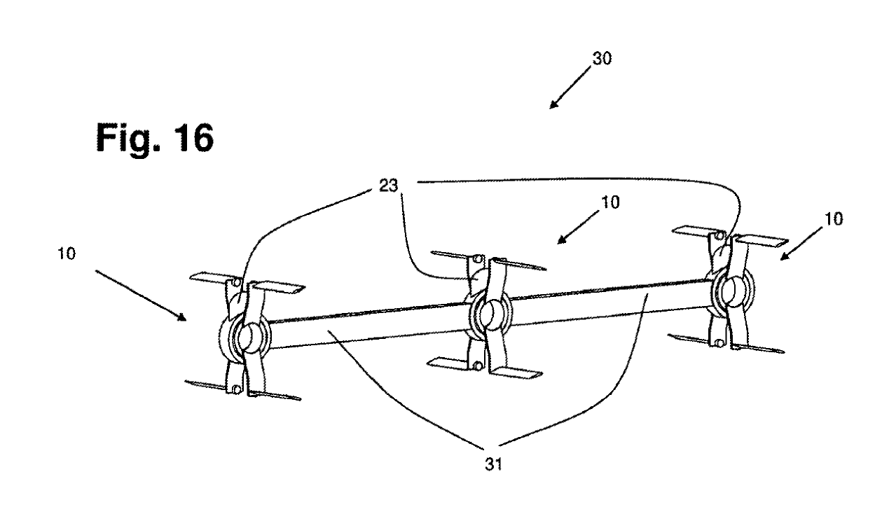

FIG. 16 shows an alternative embodiment of an advantageous wave energy converter 30, having a largely horizontal frame extent and a plurality of two-sided rotors. As compared with an arrangement having one-sided rotors, this is a particularly advantageous embodiment, since the number of generators is thereby reduced.

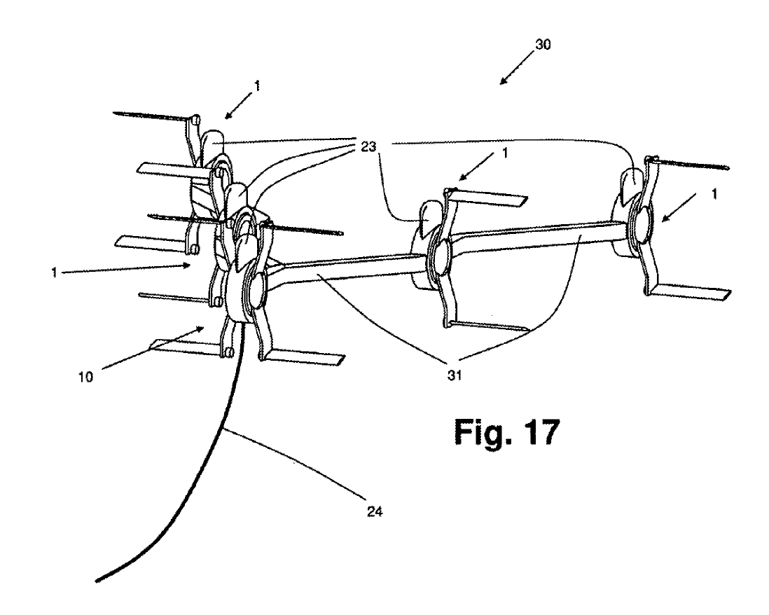

FIG. 17 shows a further alternative embodiment of an advantageous wave converter 30, having a combination of a two-sided rotor and a plurality of one-sided rotors and a largely horizontal frame extent. In this case, the frame 31 is realized as a V, in order to avoid and/or minimize shadow effects between the different rotors.

Also represented is an anchorage 24, which preferably acts at the tip of the V-shaped arrangement, such that the wave energy converter 30 is preferably to a large extent self-aligning in relation to the wave, as a result of weathervane effects, such that the latter flows against it from the front. This already results in a largely perpendicular incident flow on the rotor axes, which can be optimized yet further, for example, by influencing the rotor forces.

The lift systems that are preferably present may already generate a counter-torque, but it is also possible to include the anchorage forces of the mooring system 24, as has been described in connection with FIG. 14. In addition, guys and/or bracings may be provided to stabilize the frame. Moreover, stabilization may also be provided through the use of damping plates, in a manner similar to that in FIG. 13.

The wave energy converter 30 according to FIGS. 15 to 17 can also be influenced in its position and motion behavior by influencing the rotor forces of the individual rotors. Also possible in this case, in particular, is rotation about the vertical axis, if the various rotors are controlled accordingly by open-loop/closed loop control.

In addition to stabilization through the rotor forces, stabilization of the wave energy converter 30 is also additionally effected by using the flow-induced forces acting on the frame 31. These forces are also oriented in various directions, and may at least partially compensate each other.

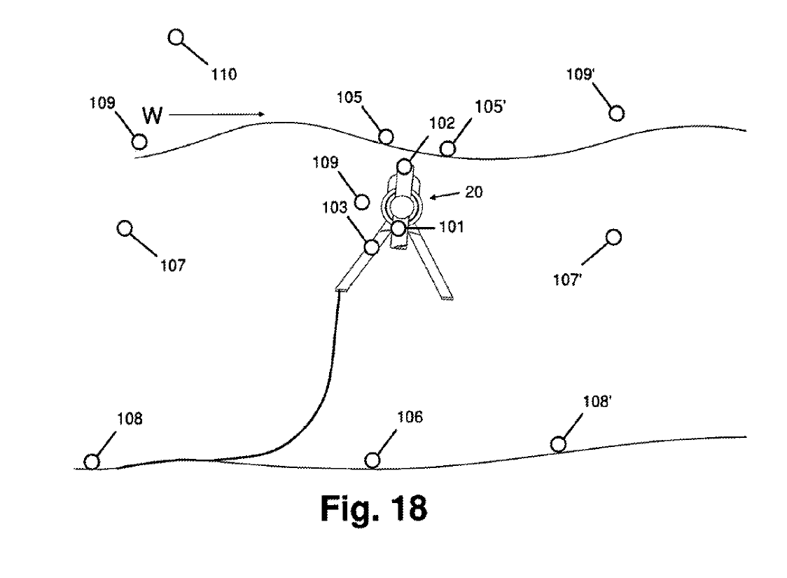

FIG. 18 shows various preferred sensor positions for the attachment of sensors for the purpose of determining the flow conditions on a wave energy converter 20 and, particularly preferably, for determining the local incident flow conditions on the coupling bodies of a wave energy converter. In addition, sensors attached to the wave energy converter 20 make it possible to determine the motion behavior of the latter. A direction of wave propagation is denoted by W.

In order to achieve the required synchronism and/or the selective influencing of the rotor forces, it is advantageous to know the incident flow conditions at the coupling bodies, particularly the local flow velocity and direction. For this purpose, sensors may be disposed on the rotor (position 101), and/or on the coupling bodies (position 102), and/or on the frame (position 103), and/or under the surface of the water, floating close to the machine (position 104), and/or on the surface of the water, close to the machine (position 105), and/or on the seabed, beneath the machine (position 106), and/or under the surface of the water, floating in front of the machine (or in front of a park of several machines) (position 107), and/or on the seabed, in front of the machine (or in front of a park of several machines) (position 108), and/or floating in front of the machine (or in front of a park of several machines) (position 109), and/or above the surface of the water (position 110)—for example, in a satellite. Additional corresponding sensors 105′ to 109′ may be disposed on the lee side, relative to the direction of wave propagation. Such lee-side sensors make it possible to determine an interaction of the wave energy converter with the incoming waves. On the basis of this knowledge, the result of the interaction can be verified and, if appropriate, the interaction can be altered in a targeted manner via a machine control system.

For this, it is possible to use sensors and corresponding combinations from, amongst others, the following categories:
pressure sensors (for determining differential and/or absolute pressure), for the purpose of determining hydrostatic and/or hydrodynamic pressures
ultrasonic sensors, for determining flow velocities, advantageously in several dimensions
laser sensors, for determining flow velocities and/or a geometry of a water surface
acceleration sensors, for determining flow conditions and/or motions of the overall system and/or of the rotor and/or of the surface velocities of a body of water, and/or for determining the alignment of a body by detection of the earth's gravitational field
inertia sensors, for measuring various translational and/or rotational acceleration forces
mass-flow meters/flow sensors and heated-wire anemometers, for determining a flow velocity
bend transducers, for determining a flow velocity
strain sensors, for determining the deformation of the coupling bodies
anemometers, for determining a flow velocity
angle sensors (absolute or incremental), tachometers, for determining angles of attack of the coupling bodies and/or the angle of rotation of the rotor
torque sensors, for determining the adjustment and/or holding forces of the coupling-body adjustment system
force sensors, for determining the rotor force in respect of amount and direction
satellites, for determining the surface geometry of the ocean region
GPS data, for determining machine position and/or motion
gyroscopes, for determining a rotation rate

From these sensor signals, it is possible to determine, in particular predictively, the instantaneous local incident flow conditions at the coupling bodies and/or the flow field around the machine and/or the flow field flowing on to the machine/the park of several machines and/or the natural vibrations of the machine, such that the second braking moment and/or the angles of attack γ, β and/or δ of the coupling bodies 3 can be set appropriately in order to achieve the open-loop/closed-loop control targets.

The open-loop/closed-loop control targets include, in addition to optimization of the rotor moment, in particular, the maintenance of a synchronism and/or the avoidance of a flow separation at the coupling bodies and/or influencing the rotor forces for the purpose of stabilization and/or a displacement and/or a deliberate excitation of vibrations and/or a rotation of the machine to achieve correctly positioned alignment in relation to the incoming wave. Moreover, the immersion depth and also the support moment can be influenced through the open-loop/closed-loop control system, with alteration of the at least one lift system. The swing behavior of the machine can also be influenced by adapting the damping plate drag.

It appears that particularly advantageous in this case are measurements of the flow field that are already effected in front of the machine, or a park of several machines, and from which it is possible to calculate the flow field present at the machine/machines at a later point in time. In combination with a virtual model of the machine, they can be used to derive a precontrol of the control variables, which are then adapted by a closed-loop control system. Such a procedure makes it possible, in particular, to compute the major energy-bearing wave components in multichromatic sea states and to tune the open-loop/closed-loop control system of the energy converter to these components in an appropriate manner.

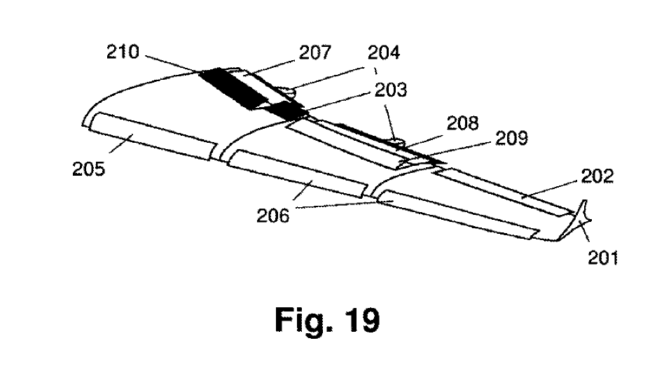

Represented in FIG. 19 and denoted by 201 to 210 are known alternative possibilities from aircraft construction, in particular flaps, for changing the angle of attack γ of a lift device and/or its shape, by means of which the surrounding flow, and therefore the lift forces and/or drag forces, can be influenced. In addition or as an alternative to actuators for adjusting the angles of attack γ, β and/or δ, the coupling bodies 3 may be equipped with one or more of these means.

In particular, the use of so-called winglets, for influencing the lift behavior at the free ends of the foil, come into consideration in this case.

Alternatively, it is possible to provide the free ends of the foil with a second rotor base, and thus also increase the mechanical stability of the overall system.

For simplicity, symmetrical profiles have been used in the illustrations. It is expressly pointed out here that curved profiles can also be used. Moreover, the curvature of the profiles used can be adapted to the flow conditions (curved flow).

1. A wave energy converter for converting energy from a wave motion of a fluid into a different form of energy, comprising:
at least one rotor coupled to at least one energy converter, the rotor having a rotor base that is two-sided in respect of its rotational plane; and
at least one coupling body attached to each side of the rotor base.

2. The wave energy converter as claimed in claim 1, wherein at least one coupling body on at least one side of the rotor base is configured to be adjustable.

3. The wave energy converter as claimed in claim 2, wherein at least one coupling body on each side of the rotor base is configured to be adjustable, and wherein the wave energy converter further comprises a mechanism configured to independently or jointly adjust the coupling bodies.

4. The wave energy converter as claimed in claim 1, wherein the coupling bodies are configured to generate a hydrodynamic lift force so as to generate a first torque that acts upon the rotor, and wherein a control device is configured to set one or more of a magnitude and a direction of the hydrodynamic lift force by altering one or more a position and a shape of the at least one coupling body.

5. The wave energy converter as claimed in claim 1, wherein the at least one coupling body is attached to at least one rotor base at a distance apart from the rotation axis of the at least one rotor.

6. The wave energy converter as claimed in claim 1, wherein the at least one energy converter is configured as a directly driven generator, wherein the at least one rotor is the drive of the generator, and wherein a generator rotor of the directly driven generator constitutes the rotor base of the at least one rotor.

7. The wave energy converter as claimed in claim 1, wherein the rotor is configured as a one-sided rotor, and at least one coupling body is attached only on one side of the rotor base.

8. The wave energy converter as claimed in claim 1, further comprising one or more of:
at least one stabilizing frame and/or damping plates configured to stabilize the wave energy converter;
an anchorage mechanism configured to anchor the wave energy converter; and
a torque support mechanism configured to absorb a torque.

9. The wave energy converter as claimed in claim 1, wherein one or more of one-sided rotors and two-sided rotors are attached to an elongate structure.

10. The wave energy converter as claimed in claim 1, further comprising a mechanism configured to alter a hydrostatic force by one or more of setting an immersion depth, tilting the wave energy converter in the fluid, and applying a torque to the wave energy converter.

11. The wave energy converter as claimed in claim 1, further comprising at least one sensor and/or at least one sensor system configured to determine a rotor position and/or coupling body position and/or a phase angle between an orbital flow and a rotational motion of the at least one rotor and/or an operating state of the wave energy converter and/or a wave state, including a wave height, a wavelength, a wave frequency, a direction of wave propagation and/or a wave propagation velocity, and/or a flow field and/or a direction of incident flow,
wherein the at least one sensor and/or the at least one sensor system include sensors disposed on the wave energy converter, in the vicinity thereof and/or at a distance therefrom.

12. A method for operating a wave energy converter including at least one rotor coupled to at least one energy converter, the rotor having a rotor base that is two-sided in respect of its rotational plane, and at least one coupling body attached to each side of the rotor base, the method comprising:
generating equal or differing first torques acting upon the rotor with the coupling bodies on both sides of the rotor base; and
generating a second torque acting upon the rotor with the energy converter.

13. The method for operating a wave energy converter as claimed in claim 12, wherein a wanted effective force acting perpendicularly in relation to the rotation axis of the at least one rotor is set by setting one or more of the first torques and the second torque.

14. The method as claimed in claim 13, wherein the generated effective force one or more of (i) alters a position of the wave energy converter in a lateral and/or vertical direction in the fluid, (ii) aligns and/or turns the wave energy converter laterally and/or vertically in the fluid, (iii) counteracts a force acting upon the wave energy converter as a result of largely continuous fluid flows, (iv) stabilizes the wave energy converter, and (v) selectively changes a motion state of the wave energy converter.

15. The method as claimed in claim 14, wherein the wave energy converter is aligned in relation to a particular orbital flow and/or direction of wave propagation in the fluid.

16. The method as claimed in claim 13, wherein a plurality of rotors are used and in each case an equal or differing effective force is generated.

17. The method as claimed in claim 13, wherein the wave motion is an orbital flow, and a rotational motion of the at least one rotor about the rotor axis is largely or completely synchronized with the orbital flow by selective setting of the first and/or second torque.

18. The method as claimed in claim 17, wherein a phase angle between the orbital flow and the rotational motion of the at least one rotor is set or regulated to a value or within a value range.

19. The method as claimed in claim 17, wherein the first torques and/or the second torque is/are altered cyclically, in each case, according to a frequency of the wave motion and/or a rotational motion of the at least one rotor, and wherein the effective force is a force that, averaged over time, results from a reaction force acting upon a holding structure of the at least one rotor.

20. The method as claimed in claim 12, wherein:
local, regional and/or global incident flow conditions of the fluid in respect of the wave energy converter and/or its components, and/or an alignment of the wave energy converter, and/or a motion state of the wave energy converter, and/or a phase angle between an orbital flow and a rotational motion of the at least one rotor, are acquired, in respect of time, as operating conditions, and used for setting the first torques and/or the second torque; and
multichromatic fluctuations of the operating conditions are acquired and main modes in the multichromatic fluctuations are used for setting the first and/or second torque.

21. (canceled)
